(19) United States
(12) Patent Application Publication
(10) Pub. No.: US 2016/0116903 A1
(43) Pub. Date: Apr. 28, 2016

(54) TILE DESIGN METHOD AND SYSTEM

(71) Applicant: Juan Carlos Guerra Igarza, Portland, OR (US)

(72) Inventor: Juan Carlos Guerra Igarza, Portland, OR (US)

(21) Appl. No.: 14/868,822

(22) Filed: Sep. 29, 2015

Related U.S. Application Data
(60) Provisional application No. 62/056,888, filed on Sep. 29, 2014.

(51) Int. Cl. G05B 19/4097

(52) U.S. Cl. CPC G05B 19/4097; G05B 2219/35027

(57) ABSTRACT

A method and system for tile design production, the system comprising a processor, and a memory having executable instructions stored thereon that when executed by the processor cause the processor to receive a size of a surface, receive dimension information of a basic pattern, receive a configuration for replicating the basic pattern to cover the surface, receive selection of tiles to fill the basic pattern, generate a plurality of possible combinations of the basic pattern based on the tiles, configuration, dimension information and size of the surface, receive a selection of a given one of the possible combinations, and generate assembly instructions and a list of quantities of the selected tiles for the selected combination.

### CROSS REFERENCE TO RELATED APPLICATION

This application claim the priority of U.S. Provional Application No. 62/056,888, entitled “TILE DESIGN METHOD AND SYSTEM,” filed on Sep. 29, 2014, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present application relates to tile designs and more particularly systems for designing unique combination of tile designs.

Current tile designs are limited on themselves because they do not allow one to create different patterns and combinations but just one type of design. In order for them to create varied combinations, they need to use different colors, shapes and textures. The tile set of the present application differentiates from all other tiles and tile systems. The essence of how this set works is that when any of the tiles are put together with the same or different tile motif of the set, this creates a pattern with a variation of designs. Every time a tile is rotated a new design is formed. The tile set creates limitless and awe-inspiring combinations, empowering buyers with a unique and revolutionary design that brings a fresh (novel) look to an old and unchanging market.

Additional aspects of the present invention will be apparent in view of the description which follows.

### SUMMARY OF THE INVENTION

The present invention provides a method and system for tile design production, the system comprising a processor, and a memory having executable instructions stored thereon that when executed by the processor cause the processor to receive a size of a surface, receive dimension information of a basic pattern, receive a configuration for replicating the basic pattern to cover the surface, receive selection of tiles to fill the basic pattern, generate a plurality of possible combinations of the basic pattern based on the tiles, configuration, dimension information and size of the surface, receive a selection of a given one of the possible combinations, and generate assembly instructions and a list of quantities of the selected tiles for the selected combination.

According to one embodiment, the configuration includes the number of times the basic pattern is repeated vertically and horizontally. The configuration may also include at least one of flipping, mirroring, and rotating the basic pattern. In one embodiment, receiving the selection of tiles by the processor includes the processor receiving a color. The processor may generate the assembly instructions by generating code notations. According to one embodiment, code notations represent a tile type and a degree of rotation. In another embodiment, the code notations represent a tile type, tile color, and degree of rotation.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 through FIG. 4 illustrate exemplary tile design templates according to an embodiment of the present invention;

FIGS. 5A-J illustrates exemplary combinations as a single tile or as a set of tiles according to an embodiment of the present invention;

FIG. 6 illustrates a flowchart of a method for generating tile designs according to an embodiment of the present invention;

FIG. 7 through FIG. 10 illustrate exemplary user interface components according to an embodiment of the present invention;

FIG. 11 and FIG. 12 illustrate combinations of tile patters generated according to embodiments of the present invention;

FIGS. 13A-D illustrates notations corresponding to tile positions according to an embodiment of the present invention;

FIGS. 14A-D illustrates exemplary code generated for a given tile pattern combination according to an embodiment of the present invention;

FIGS. 15A-L illustrate exemplary assembly of tile pattern combination according to embodiments of the present invention;

FIGS. 16A-16B illustrates exemplary core patterns according to an embodiment of the present invention;

FIGS. 17A through 17D illustrates an exemplary core pattern configuration using reflection operation according to an embodiment of the present invention; and

FIG. 18 illustrates a computing system according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

An embodiment of the present invention includes a tile set system of a plurality of tiles with modular characteristics that keep on the design dimensions in a coordinated way in each one of the tiles edges. This system integrates an algorithm to calculate and generate all possible pattern combinations that allows users to create hundreds of core patterns with just one tile design without being repetitive unlike other tiles on the actual market. For example, using two tiles in a core pattern of 2×2 can create thousands of combinations without including the color and texture variables. The visual effects created by the use of this unique design, will permit a multifaceted modern approach to the world of interior design, architecture, landscape, and more.

Here a single tile design can be flipped, mirrored or rotated to create a core pattern design, then it is arranged to fill a desired work surface. Core patterns can be created from a multiple tile design as well. Any tile material either a well known as ceramic, natural stone, wood, etc., may be used in the present invention.

Tile Description:

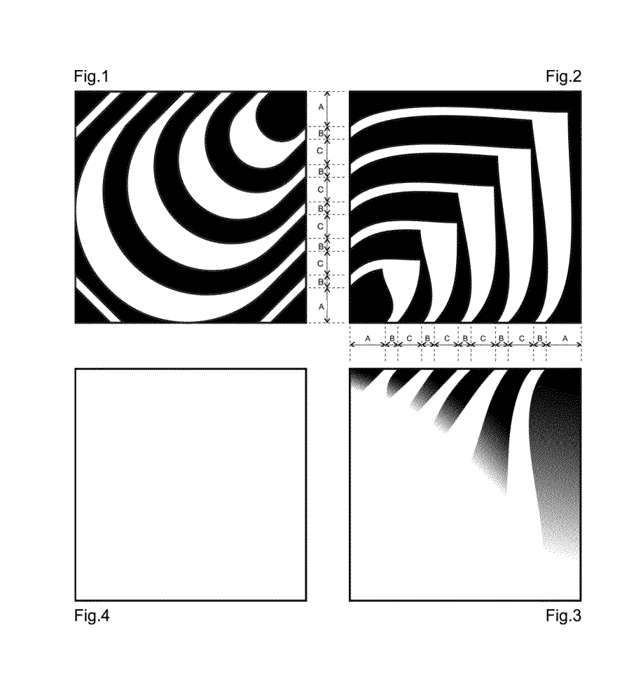

FIG. 1 presents a tile 1 (T1) Created from 4 stripes that go to a vertex (up right) reducing the radio and the thickness at the end. These stripes are symmetrical in relation to the two opposite vertices.

FIG. 2 presents a tile 2 (T2) Created from 5 semi-straight stripes that change in thickness when changing direction, keeping the same thickness to reach the edges of the slab.

FIG. 3 presents a tile 3 (T3) (the transition tile) is created with curved shapes that allow a transition of tiles (T1) and (T2) to a blank tiles, allowing the creation of different combinations such as accent tile, edging, etc.

FIG. 4 presents a tile 4 (T4) A blank tile with the same dimensions and materials of the set.

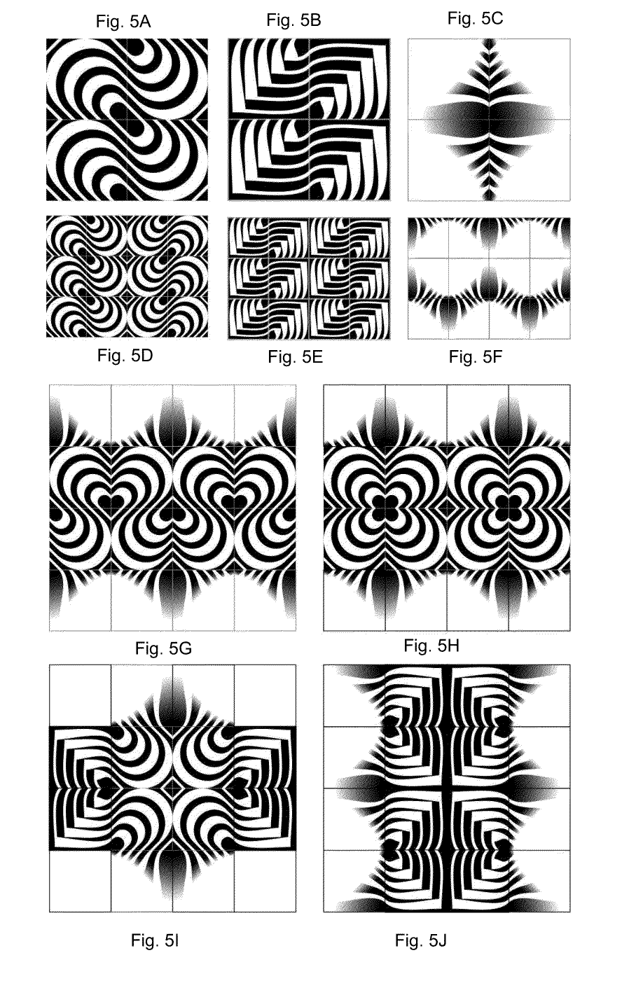

The tiles T1, T2, T3, and T4 allow multiple combinations as a single tile or as a set as illustrated in FIGS. 5A-J.

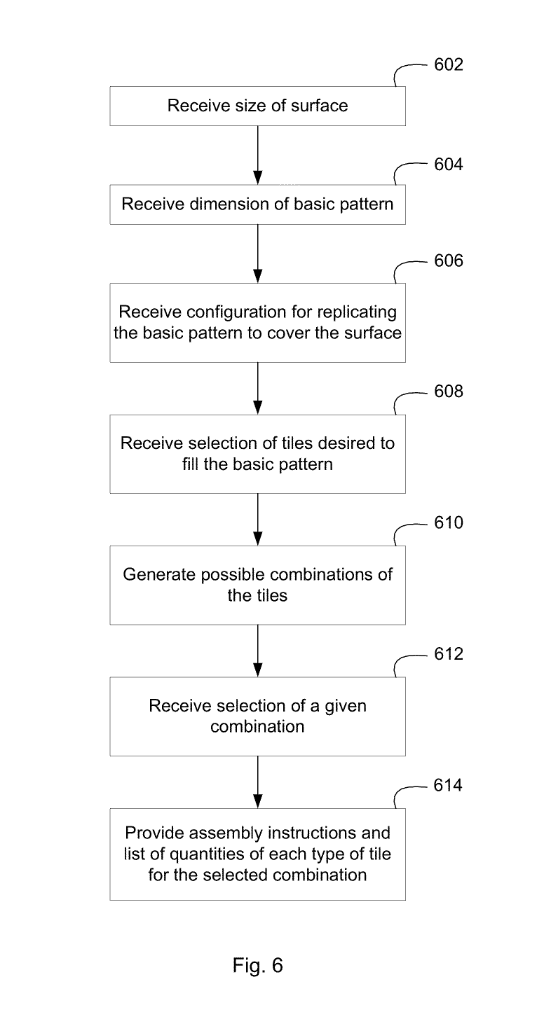

FIG. 6 presents a flowchart of a method for generating tile designs according to an embodiment of the present invention. A web portal may be accessed via a web application (desktop/mobile) that allows registered users to create, store and share over internet tile pattern combinations. Alternatively, a mobile application platform (iOS, Android, WP) may be downloaded and accessed on a client device that allows registered users to create, store and share their pattern combinations. A system interface may be provided where a user can login using an external account (from Facebook, Google or Twitter) or an internal (local) account. A project manager may be provided by the system interface that allows users to design custom tile combinations for covering a surface (such as a wall). The user can navigate to a list of projects or create a new one specifying a name and a brief description. An administrator can define dimensions, and color available for each type of tile design.

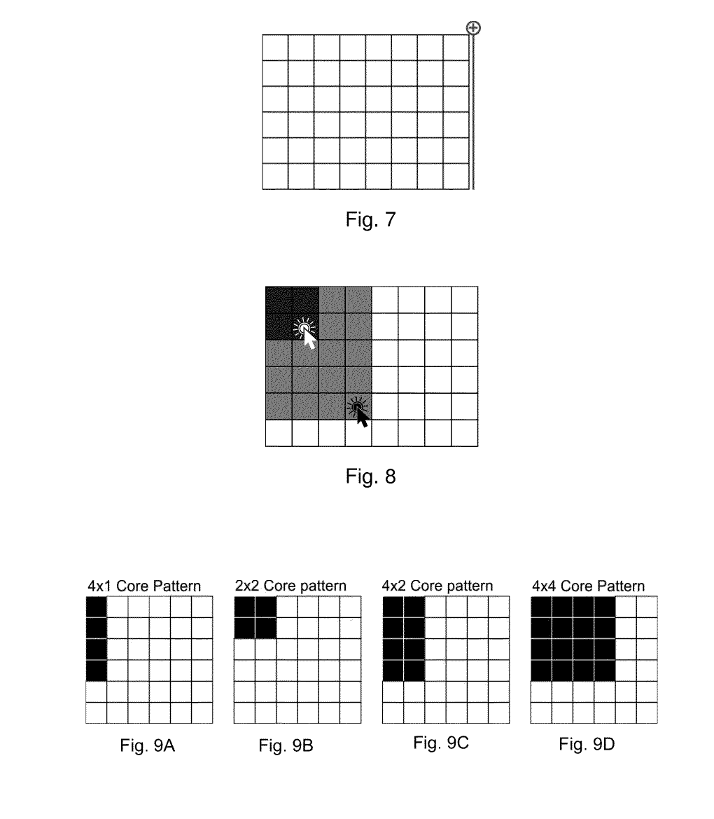

Generally, the project manager allows users to define the size of a project work surface to be covered, which tiles to use to create a core pattern, and how to replicate the pattern to cover the project work surface. A size of a surface is received, step 602. As illustrated in FIG. 7, a user may define the size of a project work surface by dragging the last column to the right (left) to add (remove) and dragging the last row down (up) for add (remove). The size of the desired surface can represent the size of an actual project work surface (e.g., the dimensions of a wall or floor).

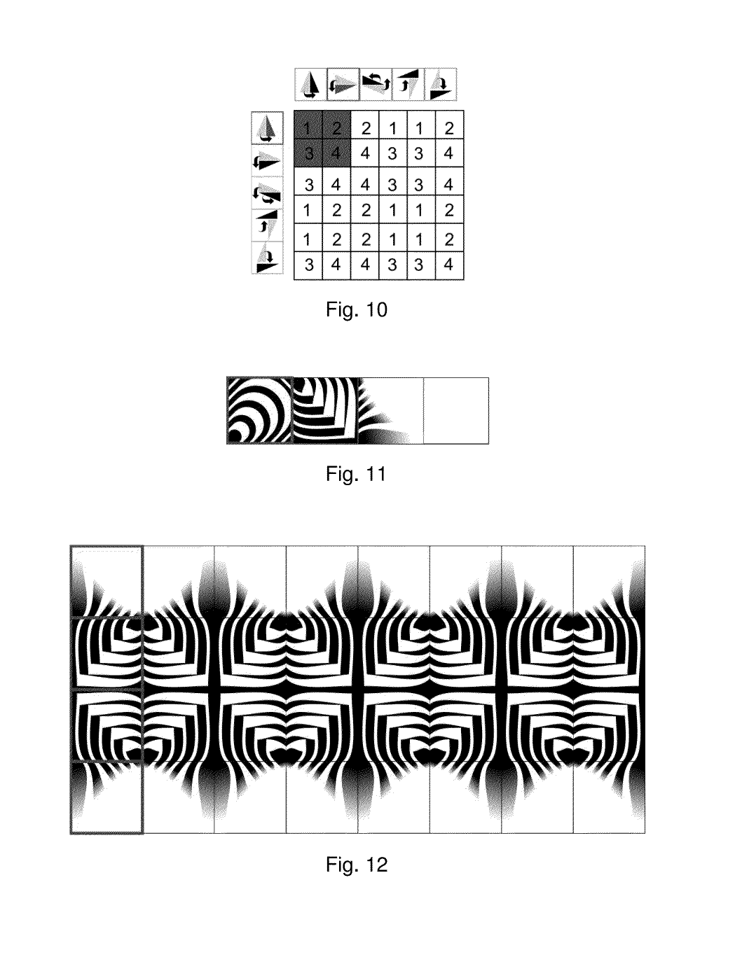

Dimension information of a basic pattern is received, step 604. The user can define the dimensions of the basic pattern such as by clicking/tapping the last cell of a pattern area (FIG. 8). The dimension information includes specifying the dimensions of a core pattern by define a core pattern (m×n) with a number of rows (m) and a number of columns (n) (FIGS. 9A-D). A configuration for replicating the basic pattern to cover the surface is received, step 606. Configuration may include the number of times the core pattern is repeated vertically (down) and horizontally (to the right), and transformations (flipped, mirrored and/or rotated) to be applied in both directions. The user can define the configuration to replicate the basic pattern to cover the surface such as by clicking/tapping a corresponding icon as illustrated in FIG. 10. A selection of tiles desired to generate new patterns is received, step 608. The user can define and modify which tile patterns (tiles T1, T2, T3) and color to use for generating patterns by clicking/tapping tile icons as illustrated in FIG. 11.

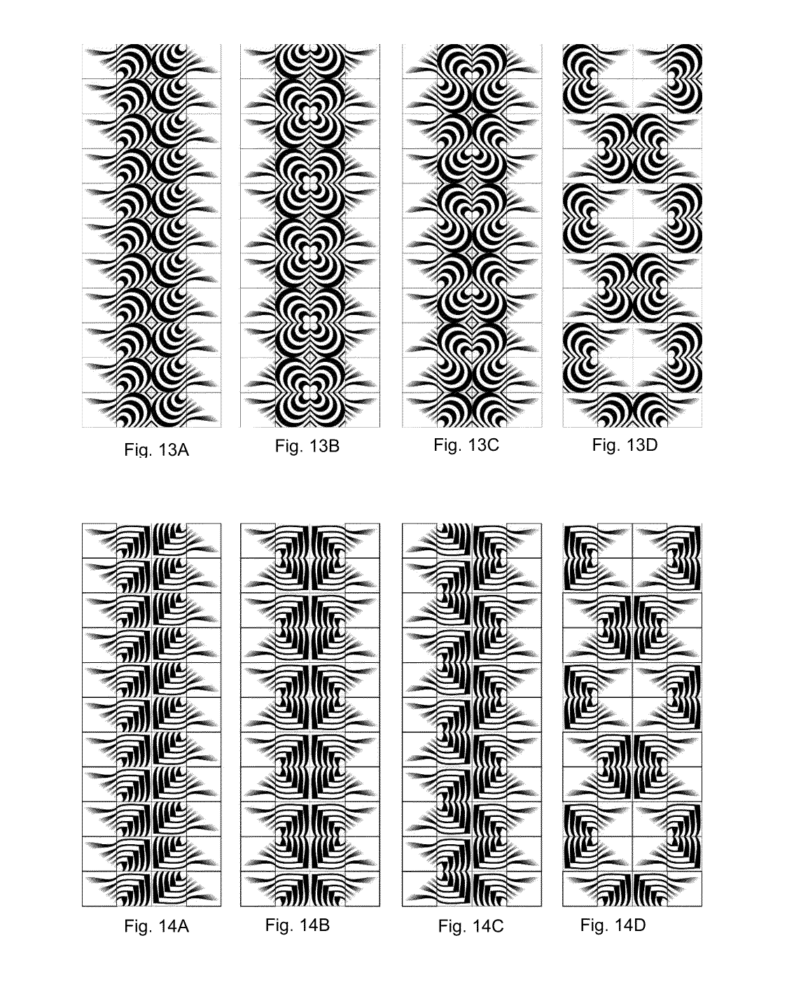

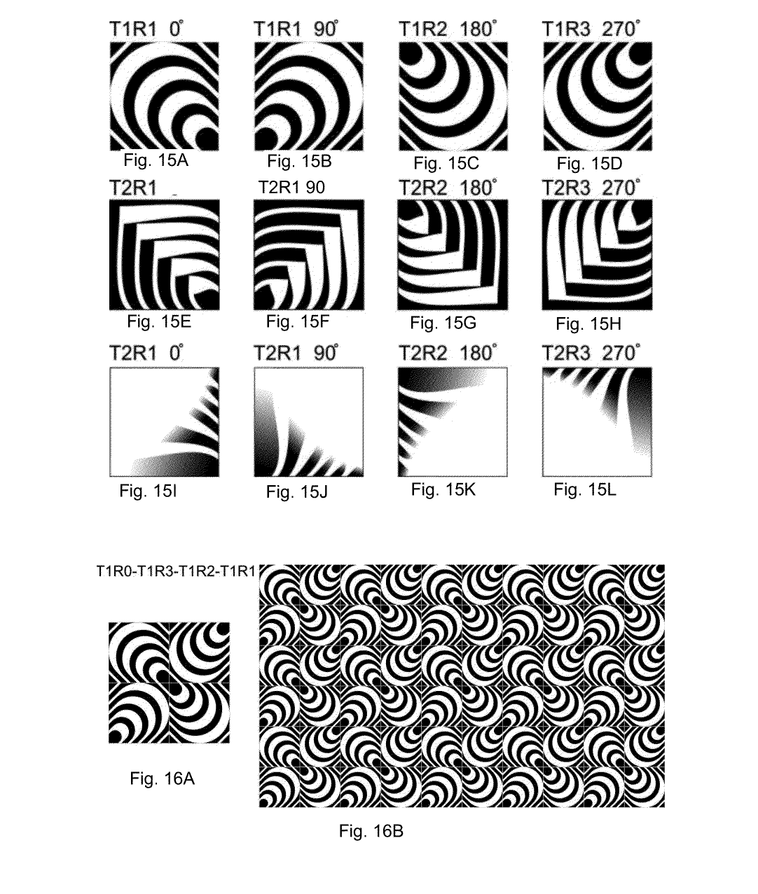

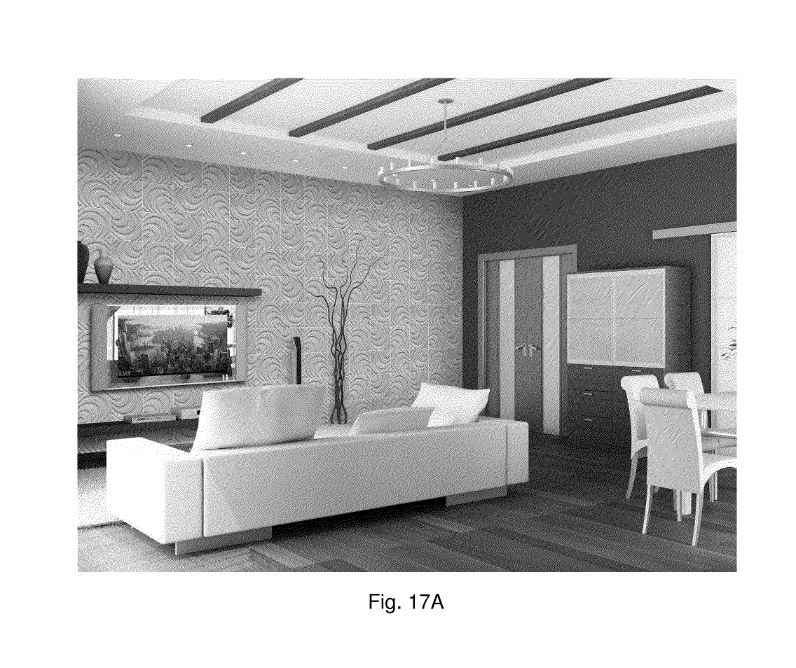

A plurality of possible combinations of the tiles are generated, step 610. The system generates and shows possible combinations of the tile patterns as illustrated in FIGS. 13A-D and FIGS. 14A-D. The system may further allow the user to make adjustments and changes to any of the generated combinations. When working with a core pattern of tiles (m×n) users are able to add/remove a column, add/remove a row, change the type of the selected tile design, change the color of the selected tile design, rotate the selected tile, and change the selected tile position (flipped, mirrored and/or rotated). FIG. 12 presents a sample of a (4×1) core pattern configuration using a reflection operation.

Users may analyze and compare all possible alternatives and select one or more generated combinations. Selection of a given combination is received, step 612. The user may also send to friends or family a link to selected combinations asking for their opinions about it. The system facilitates users to consult the opinions of their friends and/or relatives about the combinations they have chosen for their project. The system can record messages and notify the user. Users may also share their favorite tile pattern combinations. The system allows users to post images related with their projects to a picture gallery. In another embodiment, the user could post each of the selected combinations to a picture gallery. The picture gallery may include images related to both projects proposed and implemented. Each image may be associated with a set of metadata that identify the material type, the amount of tiles used and whether it is a proposal (virtual image) or an implementation (real image) and, if applicable, the geographical area where is located. Any Internet surfer can locate images by any of the available metadata.

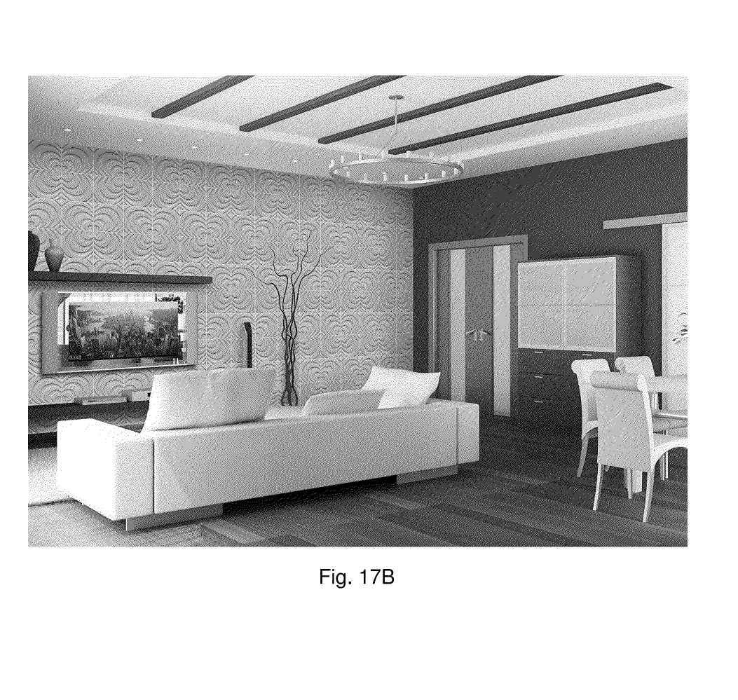

Assembly instructions and a list of the quantities of each type of tile included in the selected combination are generated, step 614. The system can generate the assembly instructions and the list of the quantities of each type of tile included in each of the defined combinations. FIGS. 15A-L present the positions of the tiles with the following code notations according to an exemplary embodiment:

1. T1-R0: Tile type 1 unrotated (0×90°.

2. T1-R1: Tile type 1 rotated 90° (1×)90°.

3. T1-R2: Tile type 1 rotated 180° (2×)90°.

4. T1-R3: Tile type 1 rotated 270° (3×90°.

FIGS. 16A-B present another sample of code generated for a 2×2 core pattern with tile T1. The colors available for each tile can be defined with the following notation:

1. T1-C1-R0: Tile type 1, color 1, unrotated (0×90).

2. T1-C2-R0: Tile type 1, color 2, unrotated (0×90).

After defining the pattern, the system can determine how many tiles are needed to cover the desired area.

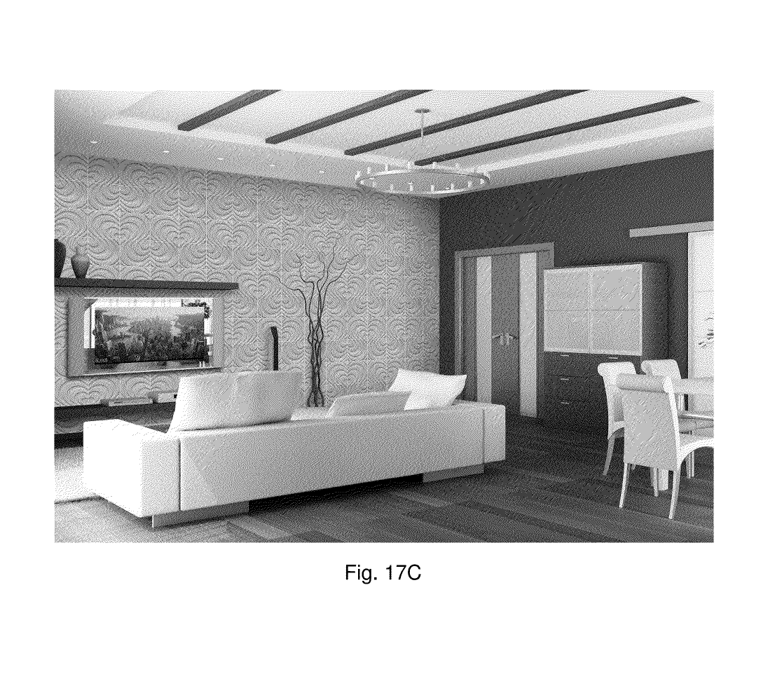

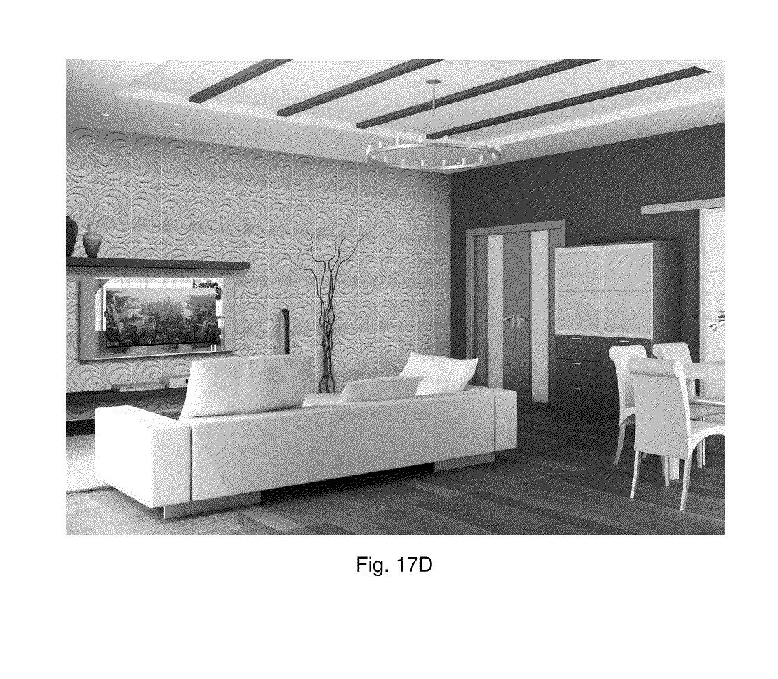

FIG. 17A through 17D presents exemplary assembly of tile pattern combination according to embodiments of the present invention.

The number of possible combinations for a (m×n) core pattern may be calculated by:

N=(SUM(Ri*Ci))^{m*n}

Where:
N=number of core pattern
Ri=number positions to rotate tile i.
Ci=total number of colors available i.
m=number of rows in the core pattern
n=number of columns in the core pattern.

TABLE 1

| | | # rotation | |
|---|---|---|---|
| i | Tile | (R) | # Color (C) |
| 1 | T1 | 4 | 1 |
| 2 | T2 | 4 | 1 |
| 3 | T3 | 4 | 1 |
| 4 | T4 | 1 | 1 |

Sample 1
2×2 Core Pattern with one tile design (T1)

N=(SUM(Ri*Ci))^{m*n}

N=(SUM(4*1))^{2*2}

N=(SUM(4))⁴

N=256

Sample 1
2×2 Core Pattern with 2 tile design (T1) and T2

N=(SUM(Ri*Ci))^{m*n}

N=(SUM(4*1+4*1))^{2*2}

N=(SUM(4+4))⁴

N=(SUM(8))⁴

N=32,768

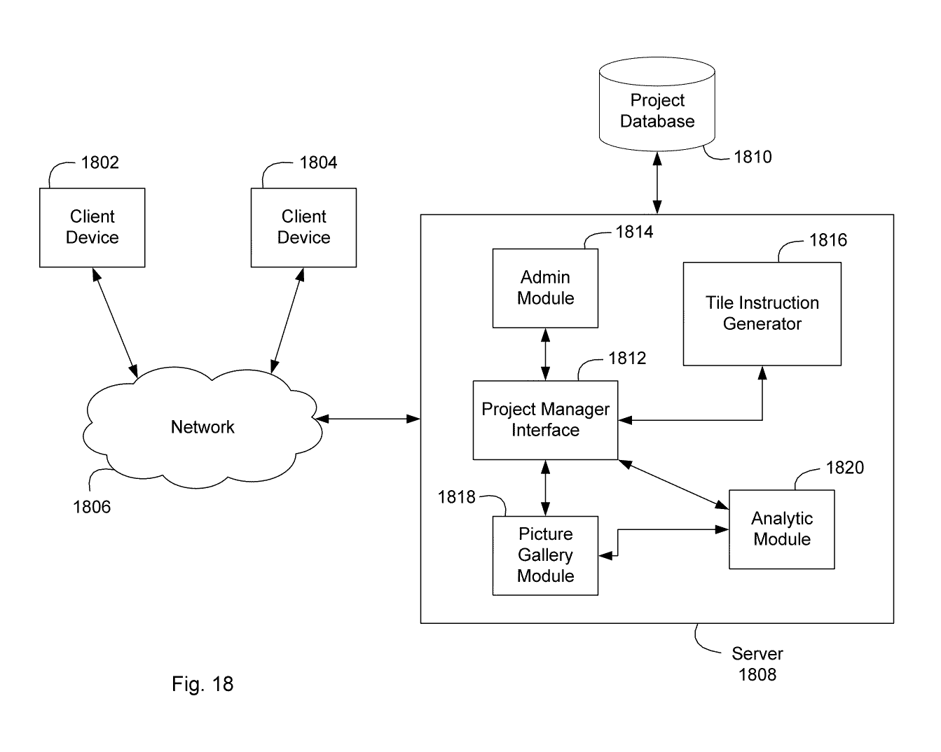

FIG. 18 presents a computing system according to an embodiment of the present invention. The computing system includes client device 1802, client device 1804, network 1806, server 1808 and project database 1810. Client devices 1802 and 1804 may comprise computing devices (e.g., desktop computers, terminals, laptops, personal digital assistants (PDA), cell phones, smartphones, tablet computers, e-book readers, or any computing device having a central processing unit and memory unit capable of connecting to a network). Client devices may also comprise a graphical user interface (GUI) or a browser application provided on a display (e.g., monitor screen, LCD or LED display, projector, etc.). A client device may vary in terms of capabilities or features. For example, a client device may be web-enabled and include one or more physical or virtual keyboards, mass storage, and a display such as a touch-sensitive color 2D or 3D display.

A client device may also include or execute an application to communicate content, such as, for example, textual content, multimedia content, or the like. A client device may also include or execute an application to perform a variety of possible tasks, such as browsing, searching, playing various forms of content, including locally stored or streamed video or images. A client device may include or execute a variety of operating systems, including a personal computer operating system, such as a Windows, Mac OS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples.

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. A social network may include individuals with similar experiences, opinions, education levels or backgrounds.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so called ‘virtual persons.’ An individual's social network may be represented in a variety of forms, such as visually, electronically or functionally. For example, a “social graph” or “socio-gram” may represent an entity in a social network as a node and a relationship as an edge or a link.

Network 1806 may be any suitable type of network allowing transport of data communications across thereof. The network 1806 may couple devices so that communications may be exchanged, such as between servers and client devices or other types of devices, including between wireless devices coupled via a wireless network, for example. A network may also include mass storage, such as network attached storage (NAS), a storage area network (SAN), cloud computing and storage, or other forms of computer or machine readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from client devices may be encrypted using, for example, the Advanced Encryption Standard (AES) with a 256-bit key size, or any other encryption standard known in the art.

Servers, as described herein, may vary widely in configuration or capabilities but are comprised of at least a special-purpose digital computing device including at least one or more central processing units and memory. A server may also include one or more of mass storage devices, power supplies, wired or wireless network interfaces, input/output interfaces, and operating systems, such as Windows Server, Mac OS X, Unix, Linux, FreeBSD, or the like.

Server 1808 is operative to receive requests from client device 1802 and client device 1804, and process the requests to generate responses to the client devices across the network 1806. The server 1808 includes project manager interface 1812, admin module 1814, tile instruction generator 1816, picture gallery module 1818, and analytic module 1820. Project manager interface 1812 is accessible via client devices 1802 and 1804 to create and access projects. The project manager interface is operable to receive requests from the client device to create tile projects, specify and configure pattern selections, generate renderings, save projects, share tile patterns to other users or social media, and purchase of tiles. Projects may be stored and retrieved from project database 1810. Admin module 1814 is configurable to allow administrators to configure the system and to perform user administration. The admin module 1814 may also be used to configure the availability of tiles for selection. Tile availability and options may be based on inventory or fabrication data received from a connection to for example, a warehouse server (not illustrated).

Tile instruction generator 1816 generates code and assembly instructions for tiles. The tile instruction generator 1816 may further send an order for tiles based on a project to a warehouse or manufacturing server for producing the tiles. Sending the ordering can include sending instructions to produce and print assembly/code notation on the tiles or on a blueprint for assembling the tiles. As such, tile projects created using project manager interface can be integrated into tile production, manufacturing, and packaging. The described steps specifically relate to the particular pattern variables used, how the pattern variables are gathered, the process by which the tiles are produced, collated, and how the tiles should be arranged.

Picture gallery module 1818 is operable to allow users to post images related with their projects to a virtual picture gallery. The picture gallery may include images related to both projects proposed and implemented. Each image may be associated with a set of metadata that identify the material type, the amount of tiles used and whether it is a proposal (virtual image) or an implementation (real image) and, if applicable, the geographical area where is located. Metadata associated with each image may also be modified depending on usage and new user requirements. Analytic module 1820 is capable of allowing authorized users to access a set of reports and graphs that facilitate analysis, by geographical area, of the evolution of the number of images published, types of tiles, used materials, and projects proposed or implemented.

Accordingly, the totality of the steps and components of the described system act in concert to improve another technical field, specifically the field of tile manufacturing and distribution, by controlling the operation of the fabrication.

FIGS. 1 through 18 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A system for tile production, the system comprising:
a processor; and
a memory having executable instructions stored thereon that when executed by the processor cause the processor to:
receive a size of a surface;
receive dimension information of a basic pattern;
receive a configuration for replicating the basic pattern to cover the surface;
receive selection of tiles to fill the basic pattern;
generate a plurality of possible combinations of the basic pattern based on the tiles, configuration, dimension information and size of the surface;
receive a selection of a given one of the possible combinations; and
generate assembly instructions and a list of quantities of the selected tiles for the selected combination.

2. The system of claim 1, wherein the configuration includes the number of times the basic pattern is repeated vertically and horizontally.

3. The system of claim 1, wherein the configuration includes at least one of flipping, mirroring, and rotating the basic pattern.

4. The system of claim 1, wherein the processor receives the selection of tiles includes the processor receiving a color.

5. The system of claim 1, wherein the processor generates the assembly instructions by generating code notations.

6. The system of claim 5, wherein the code notations represent a tile type and a degree of rotation.

7. The system of claim 5, wherein the code notations represent a tile type, tile color, and degree of rotation.
